(19) United States
(12) Patent Application Publication
(10) Pub. No.: US 2023/0048044 A1
(43) Pub. Date: Feb. 16, 2023

(54) AUTONOMOUS VEHICLE, SYSTEM, AND METHOD OF OPERATING ONE OR MORE AUTONOMOUS VEHICLES FOR THE PACING, PROTECTION, AND WARNING OF ON-ROAD PERSONS

(71) Applicant: Toyota Motor Engineering & Manufacturing North America, Inc., Plano, TX (US)

(72) Inventors: Yu Liu, Novi, MI (US); Brian A. Mulrooney, Garden City, MI (US); John-Michael McNew, Ann Arbor, MI (US)

(73) Assignee: Toyota Motor Engineering & Manufacturing North America, Inc., Plano, TX (US)

(21) Appl. No.: 17/402,044

(22) Filed: Aug. 13, 2021

(51) Int. Cl. B60W 60/00; B60Q 5/00; B60Q 1/50; A63B 24/00

(52) U.S. Cl. CPC B60W 60/0025; B60Q 5/005; B60Q 1/50; A63B 24/0062; B60W 2554/404; B60W 2552/00; B60W 2554/4026; B60W 2554/4029; B60W 2554/20; A63B 2220/13; A63B 2225/50

(57) ABSTRACT

Systems, methods, and computer program products to enhance the situational competency and/or the safe operation of a vehicle, when operating at least partially in an autonomous mode, as a support vehicle for one or more on-road persons engaged in a training or competitive cycling, running, and/or walking activity on a predetermined travel route at a predetermined pace.

### TECHNICAL FIELD

One or more embodiments relate generally to an autonomous vehicle, systems for implementation in an autonomous vehicle, a method of operating an autonomous vehicle, and a computer program product for operating an autonomous vehicle for the protection and warning of one or more on-road persons or athletes engaged in a cycling, running, and/or walking activity.

### BACKGROUND

During road athletic competitions or training of runners, walkers, and/or cyclists, one or more support vehicles. Such support vehicles generally include a lead vehicle that drives in front of the athletes and a chase vehicle that drives behind the athletes. Such support vehicles, however, require a human operator or driver.

### BRIEF SUMMARY

One or more embodiments relate to systems, methods, and computer program products that are configured to enhance the situational competency of a vehicle, when operating at least partially in an autonomous mode, in support of one or more on-road persons in a peloton (“group” or “pack”) configuration engaged in a cycling, running, and/or walking activity. Such systems, methods, and computer program products are to facilitate operation of a vehicle, when operating at least partially in an autonomous mode along a predetermined travel route in a roadway environment to function as a pace vehicle and/or a chase vehicle that dynamically communicates with the peloton to maintain a predetermined pace program, monitor the health of the on-road persons, assist disabled on-road persons, and protect the peloton against hazardous conditions (health, traffic, road, weather, etc.). For instance, the vehicle is configured to, in response to detected roadway objects that may be positioned in a blind spot to the on-road persons, automatically send a warning signal to the on-road persons. Such coordination is to dynamically take into consideration as sensor data, one or more sensor data inputs, including, but not limited to, the predetermined pace program, the travel route, the health condition of the peloton, road conditions, a presence of objects in the external driving environment, the geometric roadway design, current roadway conditions, ambient temperature, etc. As described herein, “geometric roadway design” means the three-dimensional layout of the roadway. The geometric road design may include horizontal alignment (e.g., curves and tangents), vertical alignment (e.g., vertical curves and grades), and cross-section (e.g., lanes and shoulders, curbs, medians, roadside slopes and ditches, and sidewalks). As described herein, “roadway conditions” means the surface condition of the roadway, such as, for example, the presence of moisture, debris, cracking, potholes, ice, etc.

In accordance with one or more embodiments, in order to facilitate dynamic vehicle-to-person (V2P) communications and tracking of the peloton, the peloton may be equipped with one or more wearable electronic devices, including, but not limited to, a smartwatch, a mobile device, smart eyewear, a helmet equipped with a display, a GPS tracker to be worn on an article of clothing, etc.

In accordance with one or more embodiments, the systems, methods, and computer program products for implementation in a vehicle, when operating at least partially in an autonomous mode, to cause the vehicle to dynamically track the movement of the peloton and one or more detected objects (e.g., vehicles, on-road persons, pedestrians, animals, etc.) in the external driving environment, including a lane presently occupied by the peloton and adjacent lanes thereto.

In accordance with one or more embodiments, the systems, methods, and computer program products for implementation in a vehicle, when operating at least partially in an autonomous mode, to cause the vehicle to classify the detected objects based on object type.

In accordance with one or more embodiments, the systems, methods, and computer program products for implementation in a vehicle, when operating at least partially in an autonomous mode, to cause the vehicle to conduct an analysis of the sensor data, wireless network data, and stored data.

In accordance with one or more embodiments, the systems, methods, and computer program products for implementation in a vehicle, when operating at least partially in an autonomous mode, to cause the vehicle, in response to the analysis, implementation of a driving maneuver in which the autonomous vehicle performs one or more actions, including but not limited to: modifying the predetermined travel route, modifying the predetermined pace program, and maintaining a predetermined distance in front of the one or more persons.

In accordance with one or more embodiments, the systems, methods, and computer program products for implementation in a vehicle, when operating at least partially in an autonomous mode, may cause, in response to an analysis of sensor data, implementation of a driving maneuver in which the vehicle autonomously changes a lane position on the roadway or positions the vehicle in a protective position in order to protect the health and safety of the peloton from detected hazards or potential hazards in the external driving environment. The vehicle may be configured to autonomously choose an optimal lane position in response to a detection of the external environment. For example, the vehicle may be configured to implement a driving maneuver in which the vehicle (and thus, the peloton) moves left for sections of the roadway without cross streets, and/or move left or right at cross streets with crossing traffic.

In accordance with the systems, methods, and computer program products set forth, described, and/or illustrated herein, in response to a detection of one or more obstacles in a same or an adjacent lane to the peloton, the vehicle may be caused to automatically transmit one or more alert or warning signals (e.g., visual, audio, haptic, etc.) to the peloton via one or more wearable electronic devices to be worn by the peloton and/or mounted on a bicycle.

In accordance with the systems, methods, and computer program products set forth, described, and/or illustrated herein, in response to the analysis of the sensor data, wireless network data, and stored data, the vehicle may be caused to dynamically modify the travel route and transmit the updated travel route to the peloton. The vehicle may also be caused to dynamically modify the travel route based on a communication from one or more on-road riders in the peloton.

In accordance with the systems, methods, and computer program products set forth, described, and/or illustrated herein, in response to a detection of a current health condition of an on-road person in the peloton, the vehicle may be caused to perform one or more of the following actions: transport the on-road person to a medical facility, contact a medical facility and/or an emergency contact on a paired phone to inform them of the current health condition of the on-road person, move the vehicle to a protective position relative to the on-road person, and/or transmit one or more of a visual warning signal, an audio warning signal, and a haptic warning signal.

In accordance with the systems, methods, and computer program products set forth, described, and/or illustrated herein, the wireless network data may include, but is not limited to the ambient temperature, the geometric roadway design data along the travel route, accident history data of the roadway along the travel route, width of a roadway lane data along the travel route, bike lane availability data along the travel route, roadway condition data along the travel route, current wind condition data (e.g., speed, direction), etc.

In accordance with the systems, methods, and computer program products set forth, described, and/or illustrated herein, the stored data may include, but is not limited to the predetermined pace program data, the predetermined travel route data, object classification data, on-road person health profile data, etc.

In accordance with the systems, methods, and computer program products set forth, described, and/or illustrated herein, the vehicle, in response to the surrounding external condition, peloton pace, and travel route, may autonomously change its lane and road lateral position to provide additional protection to the peloton. Such changes in position may be either to the left of the peloton or the right of the peloton. For instance on a road having a straight geometric design, the vehicle may implement a driving maneuver in which the vehicle autonomously moves on the left side of the lane (and peloton) to protect the peloton from oncoming traffic, whereas while crossing oncoming traffic left, the vehicle may implement a driving maneuver in which it autonomously sweeps out a path on the right side of the peloton to provide additional visibility and protection from oncoming traffic.

One or more embodiments may include a system for operating a vehicle, when operating at least partially in an autonomous mode, as a support vehicle for one or more on-road persons engaged in a cycling, running, and/or walking activity on a predetermined travel route at a predetermined pace, the system comprising one or more of: a sensor system to dynamically detect as sensor data a driving environment located externally to the vehicle, including health data of the one or more on-road persons, traffic data, and road data; one or more processors; and a non-transitory memory operatively coupled to the one or more processors comprising a set of instructions executable by the one or more processors to cause the one or more processors to: dynamically conduct an analysis of wireless network data, stored data, and the sensor data; dynamically determine, based on the analysis, one or more of a current health status of the one or more on-road persons, a current traffic condition along the predetermined travel route, and a current road condition along the predetermined travel route; and control the vehicle, in response to the determination, by causing the vehicle to transmit one or more of a visual warning signal, an audio warning signal, and a haptic warning signal to the one or more on-road persons.

One or more embodiments may include a system for operating a vehicle, when operating at least partially in an autonomous mode, as a support vehicle for one or more on-road persons engaged in a cycling, running, and/or walking activity on a predetermined travel route at a predetermined pace, the system comprising one or more of: one or more processors; and a non-transitory memory operatively coupled to the one or more processors comprising a set of instructions executable by the one or more processors to cause the one or more processors to: dynamically conduct an analysis of wireless network data, stored data, and sensor data relating to information about an external driving environment in which the vehicle is operating, including health data of the one or more on-road persons, traffic data, and road data; dynamically determine, based on the analysis, one or more of a current health status of the one or more on-road persons, a current traffic condition along the predetermined travel route, and a current road condition along the predetermined travel route; and control the vehicle, in response to the determination, by causing the vehicle to transmit one or more of a visual warning signal, an audio warning signal, and a haptic warning signal to the one or more on-road persons.

One or more embodiments may include a method of operating a vehicle, when operating at least partially in an autonomous mode, as a support vehicle for one or more on-road persons engaged in a cycling, running, and/or walking activity on a predetermined travel route at a predetermined pace, the method comprising: dynamically conducting an analysis of wireless network data, stored data, and sensor data relating to information about an external driving environment in which the vehicle is operating, including health data of the one or more on-road persons, traffic data, and road data; dynamically determining, based on the analysis, one or more of a current health status of the one or more on-road persons, a current traffic condition along the predetermined travel route, and a current road condition along the predetermined travel route; and controlling the vehicle, in response to the determination, by causing the vehicle to transmit one or more of a visual warning signal, an audio warning signal, and a haptic warning signal to the one or more on-road persons.

One or more embodiments may include a computer program product for operating a vehicle, when operating at least partially in an autonomous mode, as a support vehicle for one or more on-road persons engaged in a cycling, running, and/or walking activity on a predetermined travel route at a predetermined pace, the computer program product including at least one computer readable medium, comprising a set of instructions, which when executed by one or more processors, cause the one or more processors to perform one or more of the following actions: dynamically conduct an analysis of wireless network data, stored data, and sensor data relating to information about an external driving environment in which the vehicle is operating, including health data of the one or more on-road persons, traffic data, and road data; dynamically determine, based on the analysis, one or more of a current health status of the one or more on-road persons, a current traffic condition along the predetermined travel route, and a current road condition along the predetermined travel route; and control the vehicle, in response to the determination, by causing the vehicle to transmit one or more of a visual warning signal, an audio warning signal, and a haptic warning signal to the one or more on-road persons.

### BRIEF DESCRIPTION OF THE SEVERAL VIEWS OF THE DRAWINGS

The various advantages of the exemplary embodiments will become apparent to one skilled in the art by reading the following specification and appended claims, and by referencing the following drawings, in which:

FIG. 1 illustrates an example of a vehicle, in accordance with one or more embodiments shown and described herein.

FIG. 2 illustrates a communications system, in accordance with one or more embodiments shown and described herein.

FIGS. 3 through 6 respectively illustrate examples of an operation of one or more vehicles, in accordance with one or more embodiments.

FIG. 7 illustrates a block diagram of an example system, in accordance with one or more embodiments shown and described herein.

FIG. 8 illustrates a diagram of one or more vehicle control blocks, in accordance with one or more embodiments shown and described herein.

FIGS. 9 through 14 illustrate flowcharts of one or more example methods of operating the vehicle of FIG. 1.

### DETAILED DESCRIPTION

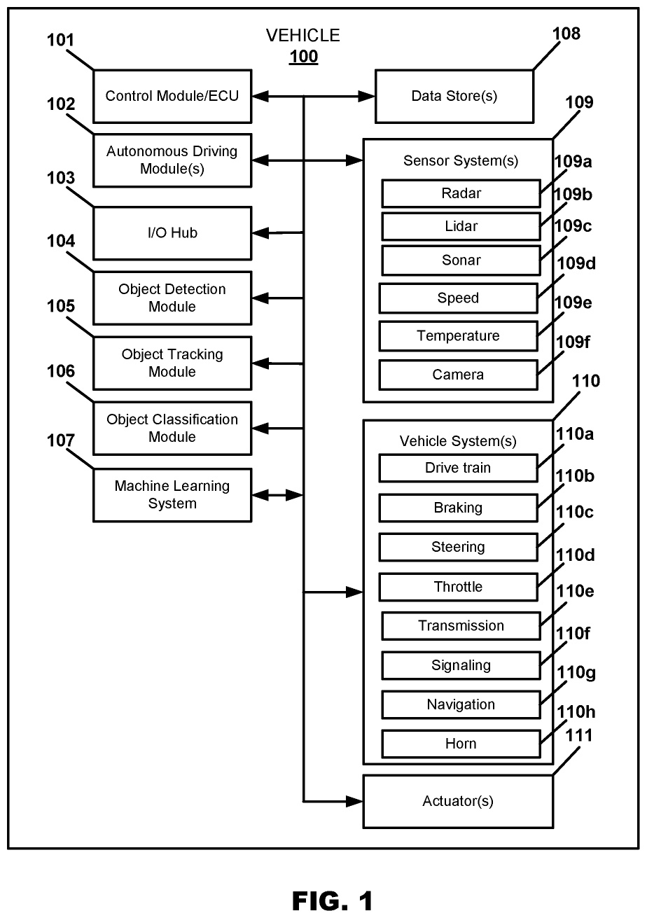

Turning to the figures, in which FIG. 1 illustrates a vehicle 100, in accordance with one or more embodiments. In accordance with one or more embodiments, a “vehicle” may be in reference to any form of motorized transport. In accordance with one or more embodiments, the vehicle 100 may comprise an automobile. Embodiments, however, are not limited thereto, and thus, the vehicle 100 may comprise a watercraft, an aircraft, or any other form of motorized transport.

In accordance with one or more embodiments, the vehicle 100 may comprise an autonomous vehicle. As described herein, an “autonomous vehicle” may comprise a vehicle that is configured to operate in an autonomous mode. As set forth, described, and/or illustrated herein, “autonomous mode” means that one or more computing systems are used to operate, and/or navigate, and/or maneuver the vehicle along a travel route with minimal or no input from a human driver. In accordance with one or more embodiments, the vehicle 100 may be configured to be selectively switched between an autonomous mode and a manual mode. Such switching may be implemented in any suitable manner (now known or later developed). As set forth, described, and/or illustrated herein, “manual mode” means that operation, and/or navigation, and/or maneuvering of the vehicle along a travel route, may, either in whole or in part, is to be performed by a human driver.

In accordance with one or more embodiments, the vehicle 100 may comprise one or more operational elements, some of which may be a part of an autonomous driving system. Some of the possible operational elements of the vehicle 100 are shown in FIG. 1 and will now be described. It will be understood that it is not necessary for the vehicle 100 to have all the elements illustrated in FIG. 1 and/or described herein. The vehicle 100 may have any combination of the various elements illustrated in FIG. 1. Moreover, the vehicle 100 may have additional elements to those illustrated in FIG. 1.

In accordance with one or more embodiments, the vehicle 100 may not include one or more of the elements shown in FIG. 1. Moreover, while the various operational elements are illustrated as being located within the vehicle 100, embodiments are not limited thereto, and thus, one or more of the operational elements may be located external to the vehicle 100, and even physically separated by large spatial distances.

In accordance with one or more embodiments, the vehicle 100 comprises a control module/ECU 101 comprising one or more processors. As set forth, described, and/or illustrated herein, “processor” means any component or group of components that are configured to execute any of the processes described herein or any form of instructions to carry out such processes or cause such processes to be performed. The one or more processors may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors may comprise at least one hardware circuit (e.g., an integrated circuit) configured to carry out instructions contained in program code. In embodiments in which there is a plurality of processors, such processors may work independently from each other, or one or more processors may work in combination with each other.

In accordance with one or more embodiments, the vehicle 100 may comprise one or more autonomous driving modules 102. The autonomous driving module 102 may be implemented as computer readable program code that, when executed by a processor, implement one or more of the various processes described herein, including, for example, determining a current driving maneuvers for the vehicle 100, future driving maneuvers and/or modifications. The autonomous driving module 102 may also cause, directly or indirectly, such driving maneuvers or modifications thereto to be implemented. The autonomous driving module 102 may be a component of the control module/ECU 101.

Alternatively, the autonomous driving module 102 may be executed on and/or distributed among other processing systems to which the control module/ECU 101 is operatively connected. The autonomous driving module 102 may include instructions (e.g., program logic) executable by the one or more processors of the control module/ECU 101. Such instructions may comprise instructions to execute various vehicle functions and/or to transmit data to, receive data from, interact with, and/or control the vehicle 100 or one or more systems thereof (e.g. one or more of vehicle systems 110). Alternatively or additionally, the one or more data stores 108 may contain such instructions.

In accordance with one or more embodiments, the vehicle 100 may comprise an I/O hub 103 operatively connected to other systems of the vehicle 100. The I/O system 103 may comprise an input interface, an output interface, and a network controller to facilitate communications between one or more vehicles 100 and the peloton 200. The input interface and the output interface may be integrated as a single, unitary interface, or alternatively, be separate as independent interfaces that are operatively connected.

The input interface is defined herein as any device, component, system, element, or arrangement or groups thereof that enable information/data to be entered in a machine. The input interface may receive an input from a vehicle occupant (e.g. a driver or a passenger) or a remote operator of the vehicle 100. In an example, the input interface may comprise a user interface (UI), graphical user interface (GUI) such as, for example, a display, human-machine interface (HMI), or the like. Embodiments, however, are not limited thereto, and thus, the input interface may comprise a keypad, touch screen, multi-touch screen, button, joystick, mouse, trackball, microphone and/or combinations thereof.

The output interface is defined herein as any device, component, system, element or arrangement or groups thereof that enable information/data to be presented to a vehicle occupant and/or remote operator of the vehicle 100. The output interface may be configured to present information/data to the vehicle occupant and/or the remote operator. The output interface may comprise one or more of a visual display or an audio display such as a microphone, earphone, and/or speaker. One or more components of the vehicle 100 may serve as both a component of the input interface and a component of the output interface.

In accordance with one or more embodiments, the vehicle 100 may comprise one or more data stores 108 for storing one or more types of data. Such data may include, but is not limited to, a predetermined pace program for the one or more on-road persons in a peloton 200 (i.e., group or pack) configuration, a predetermined travel route for the peloton 200 engaged in a training or competition sequence, traffic history on the roadway, accident history on the roadway, object types/classifications, weather history, traffic laws/guidelines based on a geographic location of the vehicle 100, etc. The vehicle 100 may include interfaces that enable one or more systems thereof to manage, retrieve, modify, add, or delete, the data stored in the one or more data stores 108. The one or more data stores 108 may comprise volatile and/or non-volatile memory. Examples of suitable one or more data stores 108 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 108 may be a component of the control module/ECU 101, or alternatively, may be operatively connected to the control module/ECU 101 for use thereby. As set forth, described, and/or illustrated herein, “operatively connected” may include direct or indirect connections, including connections without direct physical contact.

In accordance with one or more embodiments, the vehicle 100 may comprise a sensor system 109 configured, at least during operation of the vehicle 100, to dynamically detect, determine, assess, monitor, measure, quantify, and/or sense information about the vehicle 100 and a driving environment external to the vehicle 100. As set forth, described, and/or illustrated herein, “sensor” means any device, component and/or system that can perform one or more of detecting, determining, assessing, monitoring, measuring, quantifying, and sensing something. The one or more sensors may be configured to detect, determine, assess, monitor, measure, quantify and/or sense in real-time. As set forth, described, and/or illustrated herein, “real-time” means a level of processing responsiveness that a user or system senses as sufficiently immediate for a particular process or determination to be made, or that enables the processor to keep up with some external process.

The sensor system 109 may comprise for example, one or more sensors including, but not limited to ranging sensors (e.g., light detection and ranging, radio detection and ranging/radar, sound navigation and ranging/sonar), depth sensors, and image sensors (e.g., red, green, blue/RGB camera, multi-spectral infrared/IR camera). In the illustrated example of FIG. 1, the sensor system 109 comprises a radar sensor 109a, a lidar sensor 109b, a sonar sensor 109c, a speed sensor 109d, an external ambient temperature sensor 109e, and a camera 109f. The one or more sensors 109a-109f may be configured to detect, determine, assess, monitor, measure, quantify, and/or sense information about the external driving environment in which the vehicle 100 is operating, including information about objects in the external driving environment. Such objects may include, but is not limited to, peloton 200, other vehicles 300A, 300B, pedestrians, animals, fallen trees, rocks, etc. in the external driving environment. In one or more example embodiments, detection of the driving environment external to the vehicle 100 may come from one or more You Only Look Once (YOLO) detectors or one or more Single Shot Detectors (SSD).

Alternatively or additionally, the sensor system 109 may be configured to detect, determine, assess, monitor, measure, quantify and/or sense the location of the vehicle 100, the peloton 200, and the vehicles 300A, 300B operating in the external driving environment relative to the vehicle 100. Various examples of these and other types of sensors will be described herein. It will be understood that the embodiments are not limited to the particular sensors described herein.

The sensor system 109 and/or the one or more sensors 109a-109f may be operatively connected to the control module/ECU 101, the one or more data stores 108, the autonomous driving module 102 and/or other elements, components, modules of the vehicle 100. The sensor system 109 and/or any of the one or more sensors 109a-109f described herein may be provided or otherwise positioned in any suitable location with respect to the vehicle 100. For example, one or more of the sensors 109a-109f may be located within the vehicle 100, one or more of the sensors 109a-109f may be located on the exterior of the vehicle 100, one or more of the sensors 109a-109f may be located to be exposed to the exterior of the vehicle 100, and/or one or more of the sensors 109a-109f may be located within a component of the vehicle 100. The one or more sensors 109a-109f may be provided or otherwise positioned in any suitable that permits practice of the one or more embodiments.

In accordance with one or more embodiments, the one or more sensors 109a-109f may work independently from each other, or alternatively, may work in combination with each other. The sensors 109a-109f may be used in any combination, and may be used redundantly to validate and improve the accuracy of the detection.

The sensor system 109 may comprise any suitable type of sensor. For example, the sensor system 109 may comprise one or more sensors (e.g., speedometers) configured to detect, determine, assess, monitor, measure, quantify, and/or the speed of the vehicle 100 and other vehicles in the external driving environment. The sensor system 109 may also comprise one or more environment sensors configured to detect, determine, assess, monitor, measure, quantify, and/or sense other vehicles in the external driving environment of the vehicle 100 and/or information/data about such vehicles.

In accordance with one or more embodiments, the sensor system 109 may comprise one or more radar sensors 109a. As set forth, described, and/or illustrated herein, “radar sensor” means any device, component and/or system that can detect, determine, assess, monitor, measure, quantify, and/or sense something using, at least in part, radio signals. The one or more radar sensors 109a may be configured to detect, determine, assess, monitor, measure, quantify, and/or sense, directly or indirectly, the presence of objects in the external driving environment of the vehicle 100, the relative position of each detected object relative to the vehicle 100, the spatial distance between each detected object and the vehicle 100 in one or more directions (e.g., in a longitudinal direction, a lateral direction, and/or other direction(s)), the spatial distance between each detected object and other detected objects in one or more directions (e.g., in a longitudinal direction, a lateral direction, and/or other direction(s)), a current speed of each detected object, and/or the movement of each detected object, a current position of the peloton 200, and a current speed of the peloton 200.

In accordance with one or more embodiments, the sensor system 109 may comprise one or more lidar sensors 109b. As set forth, described, and/or illustrated herein, “lidar sensor” means any device, component and/or system that can detect, determine, assess, monitor, measure, quantify, and/or sense something using at least in part lasers. Such devices may comprise a laser source and/or laser scanner configured to transmit a laser and a detector configured to detect reflections of the laser. The one or more lidar sensors 109b may be configured to operate in a coherent or an incoherent detection mode. The one or more lidar sensors 109b may comprise high resolution lidar sensors.

The one or more lidar sensors 109b may be configured to detect, determine, assess, monitor, measure, quantify and/or sense, directly or indirectly, the presence of objects in the external driving environment of the vehicle 100, the position of each detected object relative to the vehicle 100, the spatial distance between each detected object and the vehicle 100 in one or more directions (e.g., in a longitudinal direction, a lateral direction and/or other direction(s)), the elevation of each detected object, the spatial distance between each detected object and other detected objects in one or more directions (e.g., in a longitudinal direction, a lateral direction, and/or other direction(s)), the speed of each detected object, and/or the movement of each detected object, the current speed of each detected object, and/or the movement of each detected object, a current position of the peloton 200, and a current speed of the peloton 200. The one or more lidar sensors 109b may generate a three-dimensional (3D) representation (e.g., image) of each detected object that may be used to compare to representations of known object types via the one or more data stores 108. Alternatively or additionally, data acquired by the one or more lidar sensors 109b may be processed to determine such things.

In accordance with one or more embodiments, the sensor system 109 may comprise one or more image devices such as, for example, one or more cameras 109f. As set forth, described, and/or illustrated herein, “camera” means any device, component, and/or system that can capture visual data. Such visual data may include one or more of video information/data and image information/data. The visual data may be in any suitable form. The one or more cameras 109f may comprise high resolution cameras. The high resolution can refer to the pixel resolution, the spatial resolution, spectral resolution, temporal resolution, and/or radiometric resolution.

In accordance with one or more embodiments, the one or more cameras 109f may comprise high dynamic range (HDR) cameras or infrared (IR) cameras.

In accordance with one or more embodiments, one or more of the cameras 109f may comprise a lens and an image capture element. The image capture element may be any suitable type of image capturing device or system, including, for example, an area array sensor, a charge coupled device (CCD) sensor, a complementary metal oxide semiconductor (CMOS) sensor, a linear array sensor, and/or a CCD (monochrome). The image capture element may capture images in any suitable wavelength on the electromagnetic spectrum. The image capture element may capture color images and/or grayscale images. One or more of the cameras may be configured with zoom in and/or zoom out capabilities.

In accordance with one or more embodiments, one or more of the cameras 109f may be spatially oriented, positioned, configured, operable, and/or arranged to capture visual data from at least a portion of the external driving environment of the vehicle 100, and/or any suitable portion within the vehicle 100. For instance, one or more of the cameras may be located within the vehicle 100.

In accordance with one or more embodiments, one or more of the cameras 109f may be fixed in a position that does not change relative to the vehicle 100. Alternatively or additionally, one or more of the cameras 109f may be movable so that its position can change relative to the vehicle 100 in a manner which facilitates the capture of visual data from different portions of the external driving environment of the vehicle 100. Such movement of one or more of the cameras 109f may be achieved in any suitable manner, such as, for example, by rotation (about one or more rotational axes), by pivoting (about a pivot axis), by sliding (along an axis), and/or by extending (along an axis).

In accordance with one or more embodiments, the one or more cameras 109f (and/or the movement thereof) may be controlled by one or more of the control module/ECU 101, the sensor system 109, and any one or more of the modules, systems, and subsystems set forth, described, and/or illustrated herein.

During operation of the vehicle 100, the processor(s) 101a may be configured to select one or more of the sensors 109 to sense the external driving environment based on current given environmental conditions including, but not limited to the roadway, other vehicles, adjacent lanes, traffic rules, objects on the roadway, etc. For example, one or more lidar sensors 109b may be used to sense the external driving environment when the vehicle 100 is operating in an autonomous mode during night time or evening time. As another example, a high-dynamic range (HDR) camera 109f may be used to sense the driving environment when the vehicle 100 is operating in an autonomous mode during daytime. The detection of objects when the vehicle 100 is operating in an autonomous mode may be performed in any suitable manner. For instance, a frame-by-frame analysis of the driving environment may be performed using a machine vision system using any suitable technique.

In accordance with one or more embodiments, the vehicle 100 may comprise an object detection module 104. The object detection module 104 may be implemented as computer readable program code that, when executed by a processor, implement one or more of the various processes set forth, described, and/or illustrated herein, including, for example, to detect objects in the driving environment. The object detection module 104 may be a component of the control module/ECU 101, or alternatively, may be executed on and/or distributed among other processing systems to which the control module/ECU 101 is operatively connected. The object detection module 104 may include a set of logic instructions executable by the control module/ECU 101. Alternatively or additionally, the one or more data stores 108 may contain such logic instructions. The logic instructions may include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

The object detection module 104 may be configured to detect objects (e.g., vehicles, on-road persons, pedestrians, etc.) operating on the roadway in any suitable manner. The detection of objects may be performed in any suitable manner. For instance, the detection may be performed using data acquired by the sensor system 109 that detects, in a driving direction of the vehicle 100, objects to one or more of the front of the vehicle 100, the rear of the vehicle 100, the left side of the vehicle 100, and the left side of the vehicle 100.

In accordance with one or more embodiments, should any objects be detected, the object detection module 104 may also identify or classify the detected objects. The object detection module 104 can attempt to classify the objects by accessing object data (e.g., object images) located in an object image database of the one or more data stores 108 or an external source (e.g., cloud-based data stores).

In accordance with one or more embodiments, the object detection module 104 may also include any suitable object recognition software configured to analyze one or more images captured by the sensor system 109. The object recognition software may query an object image database for possible matches. For instance, images captured by the sensor system 109 may be compared to images located in the object image database for possible matches. Alternatively or additionally, measurements or other aspects of an image captured by sensor system 109 may be compared to measurements or other aspects of images located in the object image database.

The object detection module 104 may identify the detected objects as a particular type of object should there be one or more matches between the captured image(s) and an image located in the object database. As set forth, described, and/or illustrated herein, a “match” or “matches” means that an image or other information collected by the sensor system 109 and one or more of the images located in the object image database are substantially identical. For example, an image or other information collected by the sensor system 109 and one or more of the images in the object image database may match within a predetermined threshold probability or confidence level.

In accordance with one or more embodiments, the vehicle 100 may comprise an object tracking module 105. The object tracking module 105 may be implemented as computer readable program code that, when executed by a processor, implements one or more of the various processes set forth, described, and/or illustrated herein, including, to one or more of follow, observe, watch, and track the movement of objects over a plurality of sensor observations. As set forth, described, and/or illustrated herein, “sensor observation” means a moment of time or a period of time in which the one or more sensors 109a-109f of the sensor system 109 are used to acquire sensor data of at least a portion of an external driving environment of the vehicle 100. The object tracking module 105 may be a component of the control module/ECU 101, or alternatively, may be executed on and/or distributed among other processing systems to which the control module/ECU 101 is operatively connected. The object tracking module 105 may comprise logic instructions executable by the control module/ECU 101. Alternatively or additionally, the one or more data stores 108 may contain such logic instructions. The logic instructions may include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

In accordance with one or more embodiments, the vehicle 100 may comprise an object classification module 106. The object classification module 106 may be implemented as computer readable program code that, when executed by a processor, implements one or more of the various processes set forth, described, and/or illustrated herein, including, for example, to classify an object in the driving environment. The object classification module 106 may be a component of the control module/ECU 101, or alternatively, may be executed on and/or distributed among other processing systems to which the control module/ECU 101 is operatively connected. The object classification module 106 may comprise logic instructions executable by the control module/ECU 101. Alternatively or additionally, the one or more data stores 108 may contain such logic instructions. The logic instructions may include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

In accordance with one or more embodiments, the object classification module 106 may be configured to detect, determine, assess, measure, quantify and/or sense, the object type of one or more detected objects in the driving environment based on one or more object features including, but not limited to, object size, object speed, shape, etc. The object classification module 106 may be configured to classify the type of one or more detected objects according to one or more defined object classifications stored in the one or more data stores 108. For example, the object classification may comprise persons, on-road persons, animals, and vehicles (e.g., cars, vans, trucks, motorcycles, buses, trailers, and semi-trailers). Embodiments, however, are not limited thereto, and thus, the object classification may comprise other object classifications.

In accordance with one or more embodiments, one or more of the modules 102-107 set forth, described, and/or illustrated herein may include artificial or computational intelligence elements, e.g., neural network, fuzzy logic, or other machine learning algorithms.

In accordance with one or more embodiments, one or more of the systems or modules 102-107 set forth, described, and/or illustrated herein may be distributed among a plurality of the modules described herein. In accordance with one or more embodiments, two or more of the systems or modules 102-107 may be combined into a single module.

In accordance with one or more embodiment, the vehicle 100 may comprise one or more vehicle systems 110, to include a drive train system 110a, a braking system 110b, a steering system 110c, a throttle system 110d, a transmission system 110e, a signaling system 110f, a navigation system 110g, a lighting system 110f. Embodiments, however, are not limited thereto, and thus, the vehicle 100 may comprise more, fewer or different systems.

The drive train system 110a may comprise one or more mechanisms, devices, elements, components, systems, and/or combinations thereof (now known or later developed), configured to provide powered motion for the vehicle 100. In accordance with one or more embodiments, the vehicle 100 may comprise a hybrid vehicle that includes a drive train system 110a having an engine (e.g., an internal combustion engine (ICE)) and a motor to serve as drive sources for the vehicle 100.

The braking system 110b may comprise one or more mechanisms, devices, elements, components, systems, and/or combinations thereof (now known or later developed), configured to decelerate the vehicle 100.

The steering system 110c may comprise one or more mechanisms, devices, elements, components, systems, and/or combinations thereof (now known or later developed), configured to adjust the heading of the vehicle 100.

The throttle system 110d may comprise one or more mechanisms, devices, elements, components, systems, and/or combinations thereof (now known or later developed), configured to control the operating speed of an engine/motor of the vehicle 100 and, in turn, the speed of the vehicle 100.

The transmission system 110e may comprise one or more mechanisms, devices, elements, components, systems, and/or combinations thereof (now known or later developed), configured to transmit mechanical power from the engine/motor of the vehicle 100 to the wheels/tires.

The signaling system 110f may comprise one or more mechanisms, devices, elements, components, systems, and/or combinations thereof (now known or later developed), configured to provide illumination for the driver or operator of the vehicle 100, the peloton 200 and/or to provide information with respect to one or more aspects of the vehicle 100. For instance, the signaling system 110f may provide information regarding the vehicle's presence, position, size, direction of travel, and/or the driver's or operator's intentions regarding direction and speed of travel of the vehicle 100. For instance, the signaling system 110f may comprise headlights, taillights, brake lights, hazard lights, and turn signal lights.

The navigation system 110g may comprise one or more mechanisms, devices, elements, components, systems, applications and/or combinations thereof (now known or later developed), configured to determine the geographic location of the vehicle 100 and/or to determine a travel route for the vehicle 100 and/or the peloton 200. The navigation system 110g may comprise one or more mapping applications to determine the travel route for the vehicle 100 and/or the peloton 200. For instance, a driver, operator, or passenger may input an origin and a destination. The mapping application can then determine one or more suitable travel routes between the origin and the destination. A travel route may be selected based on one or more parameters (e.g. shortest travel distance, shortest amount of travel time, etc.).

In accordance with one or more embodiments, the navigation system 110g may be configured to update the travel route dynamically while the vehicle 100 is in operation. In one or more example embodiments, the navigation system 110g may dynamically update the travel route of the vehicle 100 and the peloton 200, in response to an analysis of the sensor data, wireless network data, and stored data. In one or more example embodiments, the navigation system 110g may dynamically update the travel route of the vehicle 100 and the peloton 200 based on receipt of a communication from one or more on-road riders in the peloton 200 requesting a change or alternation in the travel route. The navigation system 110g may comprise one or more of a global positioning system, a local positioning system or a geolocation system. The navigation system 110g may be implemented with any one of a number of satellite positioning systems, such as the United States Global Positioning System (GPS), the Russian Glonass system, the European Galileo system, the Chinese Beidou system, the Chinese COMPASS system, the Indian Regional Navigational Satellite System, or any system that uses satellites from a combination of satellite systems, or any satellite system developed in the future. The navigation system 110g may use Transmission Control Protocol (TCP) and/or a Geographic information system (GIS) and location services.

The navigation system 110g may comprise a transceiver configured to estimate a position of the vehicle 100 with respect to the Earth. For example, navigation system 110g may comprise a GPS transceiver to determine the vehicle's latitude, longitude and/or altitude. The navigation system 110g may use other systems (e.g. laser-based localization systems, inertial-aided GPS, and/or camera-based localization) to determine the location of the vehicle 100. Alternatively or additionally, the navigation system 110g may be based on access point geolocation services, such as using the W3C Geolocation Application Programming Interface (API). With such a system, the location of the vehicle 100 may be determined through the consulting of location information servers, including, for example, Internet protocol (IP) address, Wi-Fi and Bluetooth Media Access Control (MAC) address, radio-frequency identification (RFID), Wi-Fi connection location, or device GPS and Global System for Mobile Communications (GSM)/code division multiple access (CDMA) cell IDs. It will be understood, therefore, that the specific manner in which the geographic position of the vehicle 100 is determined will depend on the manner of operation of the particular location tracking system used.

The horn system 110h may comprise one or more mechanisms, devices, elements, components, systems, applications and/or combinations thereof (now known or later developed), configured to cause the vehicle horn to transmit an audible alarm.

The processor(s) 101a and/or the autonomous driving module 102 may be operatively connected to communicate with the various vehicle systems 110 and/or individual components thereof. For example, the processor(s) 101a and/or the autonomous driving module 102 may be in communication to send and/or receive information from the various vehicle systems 110 to control the movement, speed, maneuvering, heading, direction, etc. of the vehicle 100. The processor(s) 101a and/or the autonomous driving module 102 may control some or all of the vehicle systems 110 and, thus, may be partially or fully autonomous.

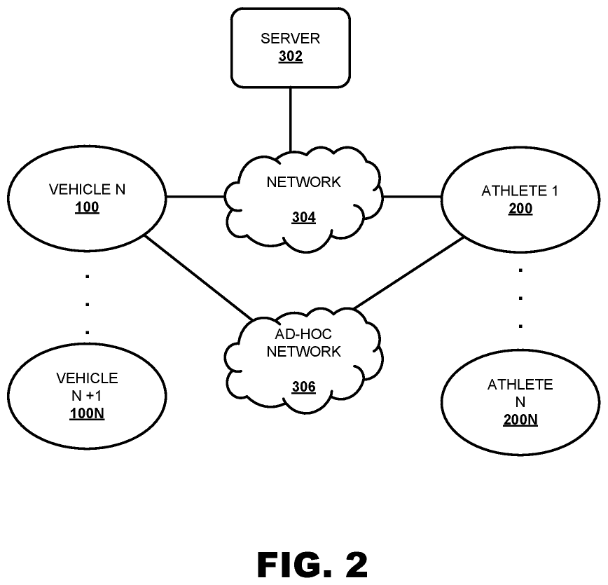

As illustrated in FIG. 2, a system for operating a vehicle 100, when operating at least partially in an autonomous mode, as a support vehicle for peloton 200, may comprise a communication environment that includes the one or more vehicles 100, the peloton 200, one or more servers 302, and a communications network 304 through which vehicle-to-vehicle (V2V) communication and vehicle-to-person (V2P) communication is facilitated. In instances where there is no connectivity at communications network 304, the control module/ECU 101, via an on-board network controller, may be configured to facilitate short range V2V communication and V2P communication using an ad-hoc wireless network 306 based on a current spatial proximity of the vehicle 100 and the peloton 200. Alternatively or additionally, the peloton 200, via the wearable electronic devices or mountable electronic devices, may form an ad-hoc wireless between themselves and have one on-road person in the peloton 200 serve as a proxy through which all V2P communications may be facilitated.

The control module/ECU 101 and/or the autonomous driving module 102 may be configured to control the navigation and/or maneuvering of the vehicle 100 by controlling one or more of the vehicle systems 110 and/or components thereof. For example, when operating in an autonomous mode, the control module/ECU 101 and/or the autonomous driving module 102 may control the direction and/or speed of the vehicle 100. The processor(s) 101a and/or the autonomous driving module 102 may cause the vehicle 100 to accelerate (e.g., by increasing the supply of fuel provided to the engine), decelerate (e.g., by decreasing the supply of fuel to the engine and/or by applying brakes) and/or change direction (e.g., by turning the wheels).

The vehicle 100 may comprise one or more actuators 111. The actuators 111 may be any element or combination of elements configured to modify, adjust and/or alter one or more of the vehicle systems 110 or components thereof to responsive to receiving signals or other inputs from the control module/ECU 101 and/or the autonomous driving module 102. Any suitable actuator may be used. For instance, the one or more actuators 111 may comprise motors, pneumatic actuators, hydraulic pistons, relays, solenoids, and/or piezoelectric actuators, etc.

In accordance with one or more embodiments, the vehicle 100 may comprise machine learning (ML) system 107. As set forth, described, or illustrated herein, machine learning means computers and/or systems having an ability to learn without being explicitly programmed. Machine learning algorithms may be used to train one or more machine learning models of the vehicle 100 based on the data that is received via the one or more of the processors of the control module/ECU 101, the one or more data stores 108, the sensor system 109, the vehicle system, 110, and any other input sources. The ML algorithms may include one or more of a linear regression algorithm, a logical regression algorithm, or a combination of different algorithms. A neural network may also be used to train the system based on the received data. The ML system 107 may analyze the received information or data related to the driving environment in order to enhance one or more of the autonomous driving module(s) 102, the object detection module 104, the object tracking module 105, the object classification module 106, the sensor system(s) 109, and the vehicle systems 110. In one or more example embodiments, such a neural network may include, but is not limited to, a YOLO neural network.

In accordance with one or more embodiments, the ML system 107 may also receive information from one or more other vehicles and process the received information to dynamically determine patterns in the detected driving environment. Information may be received based on preferences including location (e.g., as defined by geography from address, zip code, or GPS coordinates), planned travel routes (e.g., GPS alerts), activity associated with co-owned/shared vehicles, history, news feeds, and the like. The information (i.e., received or processed information) may also be uplinked to other systems and modules in the vehicle 100 for further processing to discover additional information that may be used to enhance the understanding of the information. The ML system 107 may also send information to other vehicles in the detected external driving environment, and link to other devices, including but not limited to smart phones, smart home systems, or Internet-of-Things (IoT) devices. The ML system 107 may thereby communicate with/to other vehicles of an intention to change lanes to a particular lane, thereby enhancing safety to the vehicle 100 and the peloton 200 by reducing the likelihood of a vehicle collision when implementing a driving maneuver.

In accordance with one or more embodiments, the ML system 107 may comprise one or more processors, and one or more data stores (e.g., non-volatile memory/NVM and/or volatile memory) containing a set of instructions, which when executed by the one or more processors, cause the ML system 107 to receive information from one or more of other vehicles, the processor(s) 101a, the one or more data stores 108, the sensor system 109, the vehicle system, 110, and any other input/output sources, and process the received information to, inter alia, cause implementation of a driving maneuver. Embodiments, however, are not limited thereto, and thus, the ML system 107 may process the received information to do other aspects related to operation of the vehicle 100. The ML system 107 may communicate with and collect information from one or more of other vehicles, the processor(s) 101a, the one or more data stores 108, the sensor system 109, the vehicle systems 110, and any other input/output sources to provide a deeper understanding of the monitored activities of the systems, components, and interfaces.

In accordance with one or more embodiments, the ML system 107 may utilize the capabilities of a monitoring as a service (MaaS) interface (not illustrated) to facilitate the deployment of monitoring functionalities in a cloud environment. The MaaS interface would thereby facilitate tracking by the ML system 107 of the states of systems, subsystems, components, and associated applications, networks, and the like within the cloud. The one or more other vehicles from which the machine learning subsystem receives information may include, for example, vehicles in the detected driving environment, vehicles in a user-defined area (e.g., addresses, neighborhoods, zip codes, cities, etc.), vehicles that are owned or shared by the user, vehicles along an upcoming or expected travel route (e.g., based on GPS coordinates), and the like. The received information may allow a user and a remote operator of the vehicle 100 to better monitor and recognize patterns and changes in the detected driving environment.

In accordance with one or more embodiments, the causing of a driving maneuver by the vehicle 100 to be implemented may be performed automatically (e.g., via the processor(s) and/or modules), or manually by a vehicle occupant (e.g., a driver and/or another passenger) or a remote operator of the vehicle 100. In one or more arrangements, a vehicle occupant or a remote operator may be prompted to provide permission to implement the driving maneuver. The vehicle occupant or the remote operator can be prompted by one or more sources: visually, aurally, and haptically. For example, a vehicle occupant or a remote operator may be prompted via a user interface located within a passenger compartment of the vehicle 100, or a user interface located external to the vehicle 100. Alternatively or additionally, a vehicle occupant or a remote operator may be prompted via audial output over one or more audial channels. Embodiments, however, are not limited thereto, and thus, the vehicle 100 may employ other forms of prompting as an alternative or in addition to visual, audio, and haptic prompting.

Responsive to receiving an input corresponding to approval by the vehicle occupant or the remote operator to implement the driving maneuver, the vehicle 100 may be caused to implement the driving maneuver. In accordance with one or more embodiments, the driving maneuver may be implemented only upon a determination that it may be executed safely in view of the current driving environment, including, but not limited to the roadway, other vehicles, adjacent lanes, traffic rules, objects on the roadway, etc.

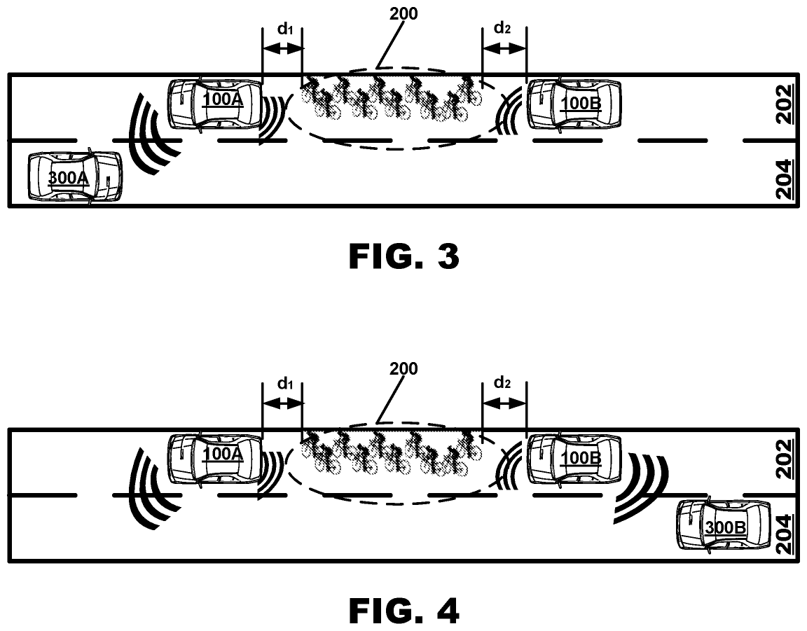

FIGS. 3 through 6 respectively illustrate, in accordance with one or more embodiments, non-limiting examples of one or more vehicles 100A, 100B operating at least partially in an autonomous mode, on a multi-lane roadway as support vehicles for peloton 200. As set forth, described, and/or illustrated herein, “roadway” means a thoroughfare, route, path, or way between two places and upon which one or more vehicles may travel. The roadway comprises a first lane 202 and a second lane 204. As set forth, described, and/or illustrated herein, a “lane” is a portion of a roadway that is designated for use by a single line of vehicles and/or a portion of a roadway that is being used by a single line of vehicles. Although the illustrated example shows a roadway comprising two lanes, embodiments are not limited thereto, and thus, the roadway may comprise any number of lanes.

In the illustrated examples, the vehicles include a forward, lead, or pace vehicle 100A that is arranged in front of the one or more on-road persons of a peloton 200 at a predetermined distance di to establish, control, and maintain the pace of the peloton 200 along the travel route, and a trail or chase vehicle 1008 arranged behind the peloton 200 at a predetermined distance d2. Each one or more on-road person in the peloton 200 may be equipped with one or more wearable electronic devices, including, but not limited to, a smartwatch, a mobile device, smart eyewear, a helmet equipped with a display, a GPS tracker to be worn on an article of clothing, etc. The pace may be autonomously adjusted by the vehicle 100A, for example, to maintain the integrity of the ad-hoc network by keeping the one or more on-road persons of the peloton 200 in close proximity to each other. The pace may also be autonomously adjusted by the vehicle 100A to maintain a single, cohesive peloton and thereby prevent the peloton 200 being splintered into two or more sub-groups (e.g., estimating a change in traffic light so as not to proceed). The pace may also be autonomously adjusted by the vehicle 100A to repair a peloton 200 that has been splintered (e.g., by a traffic light or other interference). The pace may also be autonomously adjusted by the vehicle 100A to keep another vehicle from disrupting the integrity of the peloton 200, e.g., by crossing into the peloton at a crossing stop sign. Under at least these operational scenarios, the pace vehicle 100A may autonomously estimate the future behavior/driving maneuver of a detected vehicle in order to perform such adjustments. The pace may be autonomously adjusted by the vehicle 100A in response to receipt of a communication from one or more on-road riders in the peloton 200 requesting a change in pace.

In the event of a splinter of the peloton 200 into two or more sub-groups, which compromises the overall protection of the peloton 200 using a lead-follow arrangement, the pace vehicle 100A may make one or more autonomous adjustments. As stated herein, the pace vehicle 100A reduce the pace. The pace vehicle 100A may autonomously change from a lead-follow configuration to a lead-lead or follow-follow configuration to provide better protection of the peloton 200. The pace vehicle 100A may autonomously contact (e.g., via wireless communication) one or more autonomous vehicles to rendezvous and add to the protection configuration.

The pace vehicle 100A may dynamically update the travel route based on an analysis of the sensor data, wireless network data, and stored data, and transmit the updated travel route to the one or more on-road persons 200. The vehicles 100A, 100B are configured to dynamically communicate with the peloton 200 to maintain a predetermined pace program along the travel route, monitor the health of the on-road persons 200, assist disabled on-road persons 200, and provide other assistance (e.g., change of equipment) to the peloton 200.

In the illustrated example of FIG. 3, the first lane 202 is a lane in which the vehicles 100A, 100B and the peloton 200 travel in a first direction along a predetermined travel route. The second lane 204 is a lane presently occupied by a vehicle 300A approaching the pace vehicle 100A and the peloton 200. Due to its position, the vehicle 300A may be located in a blind spot relative to the peloton 200. The pace vehicle 100A may detect, via the sensor system 109, the presence of an approaching object (i.e., vehicle 300A) from a forward position and which is classified as a vehicle operating in the second lane 204. Alternatively or additionally, the pace vehicle 100A may dynamically track, via the object tracking module 105, the movement of the detected vehicle 200. The pace vehicle 100A may determine the location or position of the detected vehicle 300A relative to one or more of the pace vehicle 100A and the peloton 200, and the rate of speed of the detected vehicle 300A. In response to the detection, the pace vehicle 100A will automatically transmit one or more alert signals to the peloton 200 and/or the trail vehicle 100B of the presence of the detected vehicle 300A by transmitting one or more of a visual warning signal (e.g., flashing lights), an audio warning signal (e.g., engage vehicle horn), and a haptic warning signal (e.g., via one or more wearable electronic devices worn by the peloton 200). The duration of the automatic alert may be a period until the detected vehicle 300A has passed the last on-road person in the peloton 200. One or more alert signals may also be transmitted to the peloton 200 as a manner of communicating in response to sensor data analysis, wireless network data, and stored data.

In the illustrated example of FIG. 4, the first lane 202 is a lane in which the vehicles 100A, 100B and the peloton 200 travel in a first direction along a predetermined travel route. The second lane 204 is a lane presently occupied by a vehicle 300B approaching the trail vehicle 100B and the peloton 200 and implementing a driving maneuver to pass the vehicles 100A, 100B and the peloton 200. Due to its position, the vehicle 300B may be located in a blind spot relative to the peloton 200. The trail vehicle 100B may detect, via the sensor system 109, the presence of an approaching object (i.e., vehicle 300B) from a rearward position and which is classified as a vehicle operating in the second lane 204. Alternatively or additionally, the trail vehicle 100B may dynamically track, via the object tracking module 105, the movement of the detected vehicle 200. The trail vehicle 100B may determine the location or position of the detected vehicle 300B relative to one or more of the trail vehicle 100B and the peloton 200, and the rate of speed of the detected vehicle 300B. In response to the detection, the trail vehicle 100B will automatically transmit an alert signal to the peloton 200 and/or the pace vehicle 100A of the presence of the approaching vehicle 300B by transmitting one or more of a visual warning signal(e.g., flashing lights), an audio warning signal (e.g., engage vehicle horn), and a haptic warning signal (e.g., via one or more wearable electronic devices worn by the peloton 200). The duration of the automatic alert may be a period until the detected vehicle 300B has passed the first on-road person in the peloton 200.

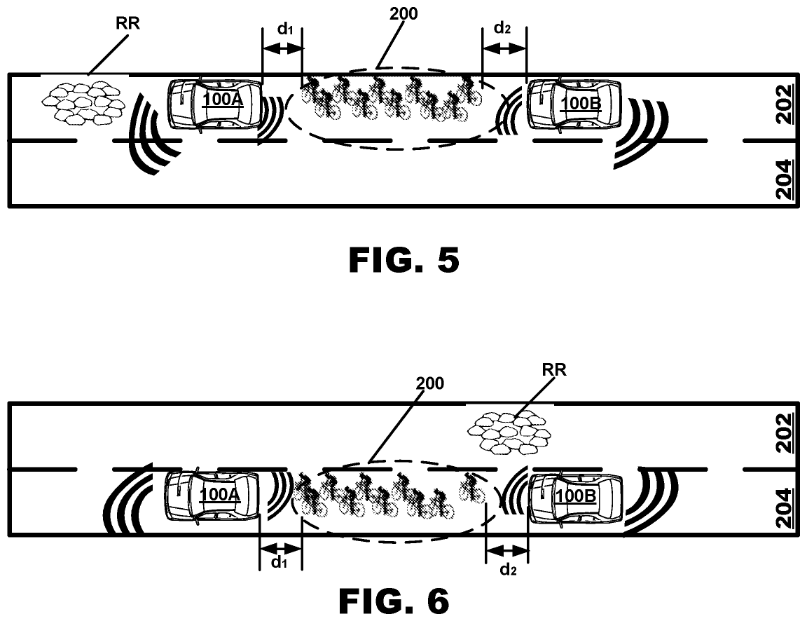

In the illustrated example of FIG. 5, the first lane 202 is a lane in which the vehicles 100A, 100B and the peloton 200 travel in a first direction along a predetermined travel route. The second lane 204 is a lane having a plurality of rocks RR thereon located in a blind spot relative to the peloton 200. The pace vehicle 100A may detect, via the sensor system 109, the presence of objects (i.e., rocks RR) in a forward position. The pace vehicle 100A may determine the location or position of the detected rocks RR relative to one or more of the pace vehicle 100A and the peloton 200. In response to the detection, the pace vehicle 100A will transmit one or more automatically alert signals to the peloton 200 and/or the trail vehicle 100B of the presence of the detected rocks RR by transmitting one or more of a visual warning signal(e.g., flashing lights), an audio warning signal (e.g., engage vehicle horn), and a haptic warning signal (e.g., via one or more wearable electronic devices worn by the peloton 200). The duration of the automatic alert may be a period until the last on-road person in the peloton 200 has passed the detected rocks RR. One or more alert signals may also be transmitted to the peloton 200 as a manner of communicating in response to sensor data analysis, wireless network data, and stored data.

As illustrated in FIG. 6, in response to the detection, the pace vehicle 100A will be caused to implement a driving maneuver to change lanes (from lane 202 to lane 204 and then back to lane 202) to avoid the detected rocks RR. In response to receipt of the one or more automatically alert signals, the peloton 200 will change lanes (from lane 202 to lane 204 and then back to lane 202) and/or the trail vehicle 100B will be caused to implement a driving maneuver to change lanes (from lane 202 to lane 204 and then back to lane 202) to avoid the detected rocks RR.

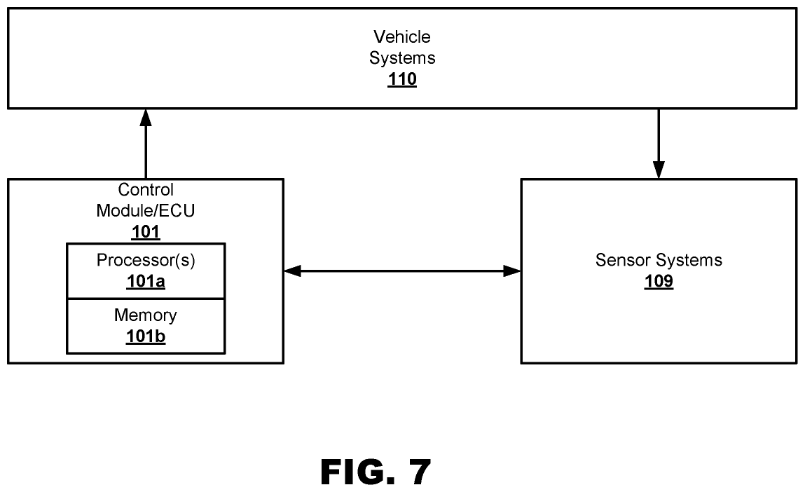

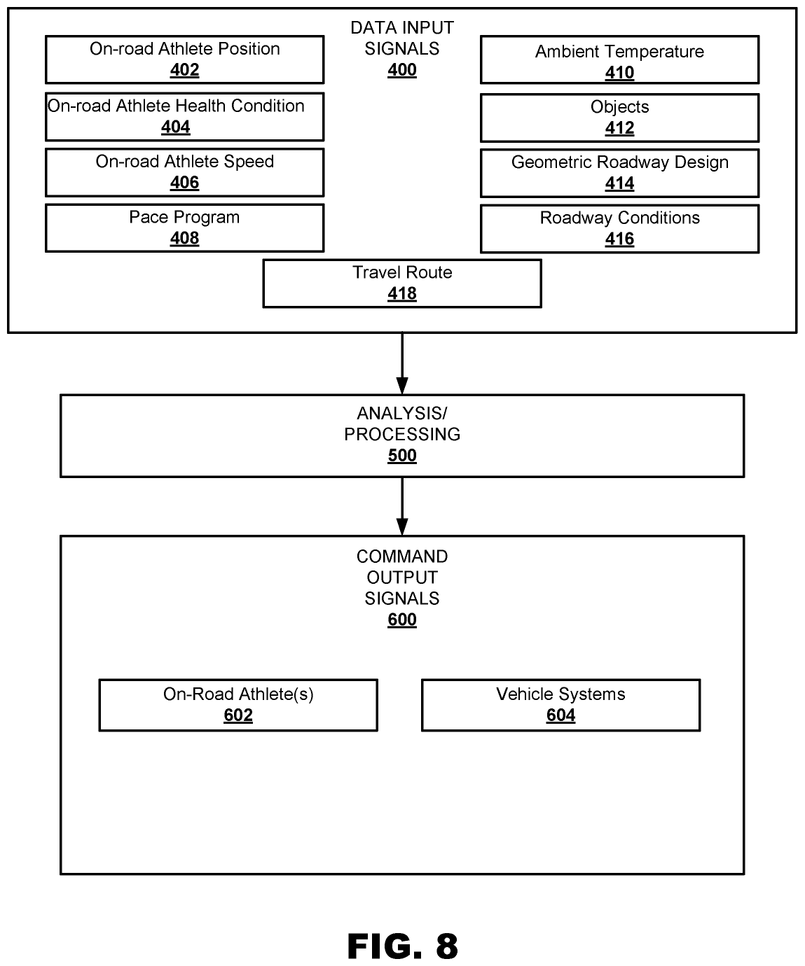

As illustrated in FIGS. 7 and 8, a system for operating a vehicle may comprise the vehicle control module/ECU 101 configured to receive one or more data input signals 400 from the sensor systems 109, wireless network 304, 306, and data stored in memory 101b to thereby control via one or more processors 101a operation of the vehicle 100 (i.e., via the vehicle systems 110) when operating at least partially in an autonomous mode as a support vehicle for the peloton 200 engaged in a training or competitive cycling, running, and/or walking activity. The data input signals include, but are not limited to, the on-road person position 402, the on-road person health condition 404, the on-road person speed 406, the predetermined pace program 408, the ambient temperature 410, objects 412, geometric roadway design 414, roadway conditions 416, and the predetermined travel route 418. The one or more processors 101a are to conduct an analysis 500 of the sensor data, and then, initiate different control sequences via command output signals 600 (e.g., to the one or more on-road persons 602 and the vehicle systems 604) for controlling the vehicle 100 based on the analysis, wireless network data, and stored data.

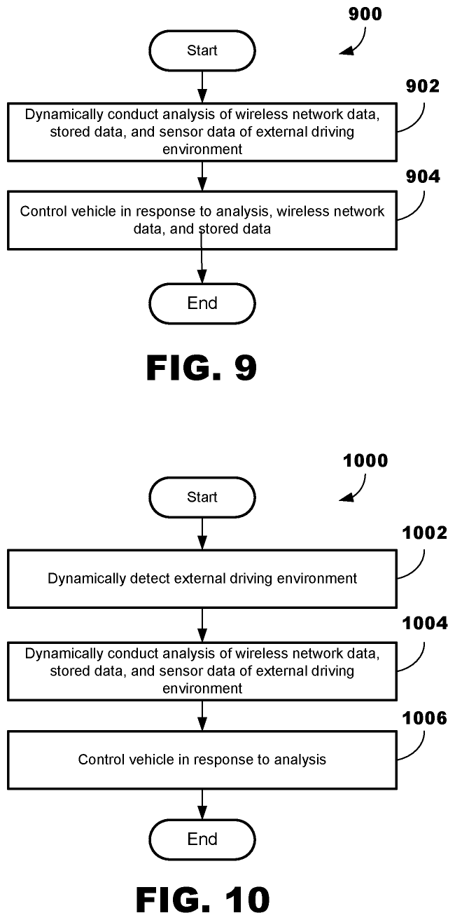

Illustrated examples shown in FIGS. 9 to 14 set forth methods 900, 1000, 1100, 1200, 1300, and 1400 for operating a vehicle, when operating at least partially in an autonomous mode, as a support vehicle for one or more on-road persons in a peloton configuration that are engaged in a cycling, running, and/or walking activity on a predetermined travel route at a predetermined pace. The methods 900, 1000, 1100, 1200, 1300, and 1400 may be implemented, for example, in logic instructions (e.g., software), configurable logic, fixed-functionality hardware logic, etc., or any combination thereof.

As illustrated in FIG. 9, illustrated process block 902 includes dynamically conducting an analysis of wireless network data, stored data, and sensor data relating to information about an external driving environment in which the vehicle is operating, including health data of the one or more on-road persons, traffic data, and road data. In accordance with one or more embodiments, execution of process block 902 may be performed by one or more of the control module/ECU 101 and the autonomous driving module 102.

The method 900 may then proceed to illustrated process block 904, which includes controlling the vehicle, in response to the analysis, by causing the vehicle to implement a driving maneuver that maintains a predetermined distance from and a predetermined pace for the one or more on-road persons. In accordance with one or more embodiments, execution of process block 904 may be performed by the control module/ECU 101.

The method 900 may terminate or end when the vehicle 100 is caused to execute or implement the driving maneuver. Alternatively, the method 900 may return to start or process block 902. In accordance with one or more embodiments, one or more of the control module/ECU 101 and the autonomous driving module 102 may cause the vehicle 100 to implement the driving maneuver to change. In this regard, one or more of the control module/ECU 101 and the autonomous driving module 102 may be operatively connected to one or more of the vehicle systems 110 to cause the driving maneuver to be implemented. Alternatively or additionally, one or more of the control module/ECU 101 and the autonomous driving module 102 may be operatively connected to and control the one or more actuators 111, which may control one or more of the vehicle systems 110 or portions thereof to implement the driving maneuver.

As illustrated in FIG. 10, illustrated process block 1002 includes dynamically detecting, as sensor data, a driving environment located externally to the vehicle, including health data of the one or more on-road persons, traffic data, and road data. In accordance with one or more embodiments, execution of process block 1002 may be performed by one or more of the control module/ECU 101, the object detection module 104, the object tracking module 105, the sensor system 109, and the navigation system 110g. At least a portion of an external driving environment of the vehicle 100 may be dynamically sensed to detect objects. For example, the vehicle 100 may sense or detect the external driving environment in one or more directions, such as: a lateral direction relative to the longitudinal axis of the vehicle 100, an aft direction relative to the longitudinal axis of the vehicle 100, and a fore direction relative to the longitudinal axis of the vehicle 100.

The method 1000 may then proceed to illustrated process block 1004, which includes dynamically conducting an analysis of wireless network data, stored data, and the sensor data. In accordance with one or more embodiments, execution of process block 1404 may be performed by one or more of the control module/ECU 101 and the autonomous driving module 102.

The method 1000 may then proceed to illustrated process block 1006, which includes controlling the vehicle, in response to the analysis, wireless network data, and stored data, by causing the vehicle to implement a driving maneuver that maintains a predetermined distance from and a predetermined pace for the one or more on-road persons. In accordance with one or more embodiments, execution of process block 1006 may be performed by the control module/ECU 101.

The method 1006 may terminate or end when the vehicle 100 is caused to execute or implement the driving maneuver. Alternatively, the method 1000 may return to start or process block 1002. In accordance with one or more embodiments, one or more of the control module/ECU 101 and the autonomous driving module 102 may cause the vehicle 100 to implement the driving maneuver. In this regard, one or more of the control module/ECU 101 and the autonomous driving module 102 may be operatively connected to one or more of the vehicle systems 110 to cause the driving maneuver to be implemented. Alternatively or additionally, one or more of the control module/ECU 101 and the autonomous driving module 102 may be operatively connected to and control the one or more actuators 111, which may control one or more of the vehicle systems 110 or portions thereof to implement the driving maneuver.

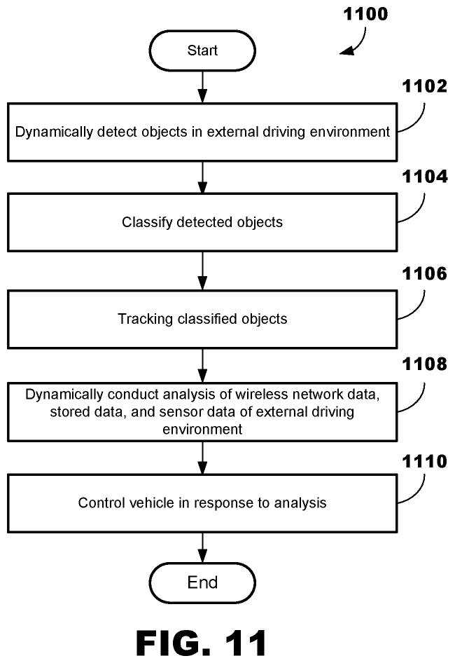

As illustrated in FIG. 11, illustrated process block 1102 includes dynamically detecting, as sensor data, objects in a driving environment located externally to the vehicle. In accordance with one or more embodiments, execution of process block 1102 may be performed by one or more of the control module/ECU 101, the object detection module 104, the object tracking module 105, the sensor system 109, and the navigation system 110g. At least a portion of an external driving environment of the vehicle 100 may be dynamically sensed to detect objects. For example, the vehicle 100 may sense or detect the external driving environment in one or more directions, such as: a lateral direction relative to the longitudinal axis of the vehicle 100, an aft direction relative to the longitudinal axis of the vehicle 100, and a fore direction relative to the longitudinal axis of the vehicle 100.

The method 1100 may then proceed to illustrated process block 1104, which includes classifying the detected objects. In accordance with one or more embodiments, the objects may be classified, based on a comparison of the detected image data with image data stored in the one or more data stores 108. The object classes may include, but is not limited to, on-road persons, pedestrians, other vehicles, animals, obstacles, barriers, etc. In accordance with one or more embodiments, execution of processing block 1104 may be performed by one or more of the control module/ECU 101, the sensor system 109, and the vehicle classification module 106.

The method 1100 may then proceed to illustrated process block 1106, which includes dynamically tracking the classified objects. Such tracking of the classified objects may occur over a plurality of sensor detection moments or frames. In accordance with one or more embodiments, execution of process block 1106 may be performed by one or more of the control module/ECU 101, the vehicle tracking module 105, and the sensor system 109.

The method 1100 may then proceed to illustrated process block 1108, which includes dynamically conducting an analysis of wireless network data, stored data, and the sensor data. In accordance with one or more embodiments, execution of process block 1108 may be performed by one or more of the control module/ECU 101 and the autonomous driving module 102.

The method 1100 may then proceed to illustrated process block 1110, which includes controlling the vehicle, in response to the analysis, wireless network data, and stored data, by causing the vehicle to implement a driving maneuver that maintains a predetermined distance from and a predetermined pace for the one or more on-road persons. In accordance with one or more embodiments, execution of process block 904 may be performed by one or more of the control module/ECU 101 and the autonomous driving module 102.

The method 1100 may terminate or end when the vehicle 100 is caused to execute or implement the driving maneuver. Alternatively, the method 1100 may return to start or process block 1102. In accordance with one or more embodiments, one or more of the control module/ECU 101 and the autonomous driving module 102 may cause the vehicle 100 to implement the driving maneuver. In this regard, one or more of the control module/ECU 101 and the autonomous driving module 102 may be operatively connected to one or more of the vehicle systems 110 to cause the driving maneuver to be implemented. Alternatively or additionally, one or more of the control module/ECU 101 and the autonomous driving module 102 may be operatively connected to and control the one or more actuators 111, which may control one or more of the vehicle systems 110 or portions thereof to implement the driving maneuver.

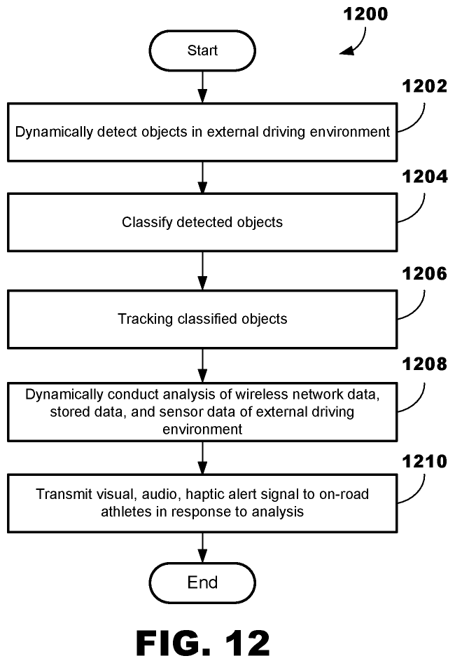

As illustrated in FIG. 12, illustrated process block 1202 includes dynamically detecting, as sensor data, objects in a driving environment located externally to the vehicle. In accordance with one or more embodiments, execution of process block 1202 may be performed by one or more of the control module/ECU 101, the autonomous driving module 102, the object detection module 104, the object tracking module 105, the sensor system 109, and the navigation system 110g. At least a portion of an external driving environment of the vehicle 100 may be dynamically sensed to detect objects. For example, the vehicle 100 may sense or detect the external driving environment in one or more directions, such as: a lateral direction relative to the longitudinal axis of the vehicle 100, an aft direction relative to the longitudinal axis of the vehicle 100, and a fore direction relative to the longitudinal axis of the vehicle 100.

The method 1200 may then proceed to illustrated process block 1204, which includes classifying the detected objects. In accordance with one or more embodiments, the objects may be classified, based on a comparison of the detected image data with image data stored in the one or more data stores 108. The object classes may include, but is not limited to, on-road persons, pedestrians, other vehicles, animals, obstacles, barriers, etc. In accordance with one or more embodiments, execution of processing block 1204 may be performed by one or more of the control module/ECU 101, the autonomous driving module 102, the sensor system 109, and the vehicle classification module 106.

The method 1200 may then proceed to illustrated process block 1206, which includes dynamically tracking the classified objects. Such tracking of the classified objects may occur over a plurality of sensor detection moments or frames. In accordance with one or more embodiments, execution of process block 1206 may be performed by one or more of the control module/ECU 101, the vehicle tracking module 105, and the sensor system 109.

The method 1200 may then proceed to illustrated process block 1208, which includes dynamically conducting an analysis of wireless network data, stored data, and the sensor data relating to the classified objects. In accordance with one or more embodiments, execution of process block 1208 may be performed by one or more of the control module/ECU 101 and the autonomous driving module 102.

The method 1200 may then proceed to illustrated process block 1210, which includes causing the vehicle to automatically transmit, in response to the analysis, wireless network data, and stored data, one or more alert signals to the peloton 200 of the presence of the detected object(s). In accordance with one or more embodiments, the alert signal comprises one or more of a visual warning signal (e.g., flashing lights), an audio warning signal (e.g., engage vehicle horn), and a haptic warning signal (e.g., via one or more wearable electronic devices worn by the peloton 200). The alert signal may be transmitted in a predetermined sequence, intensity (audio), and/or frequency to indicate the type of potential hazard posed by the detected object(s).

The method 1200 may terminate or end when the vehicle 100 is caused to execute or implement the driving maneuver and/or the automatic transmission of the one or more alert signals. Alternatively, the method 1200 may return to start or process block 1202. In accordance with one or more embodiments, one or more of the control module/ECU 101 and the autonomous driving module 102 may cause the vehicle 100 to implement the driving maneuver. In this regard, one or more of the control module/ECU 101 and the autonomous driving module 102 may be operatively connected to one or more of the vehicle systems 110 to cause the driving maneuver to be implemented. Alternatively or additionally, one or more of the control module/ECU 101 and the autonomous driving module 102 may be operatively connected to and control the one or more actuators 111, which may control one or more of the vehicle systems 110 or portions thereof to implement the driving maneuver.

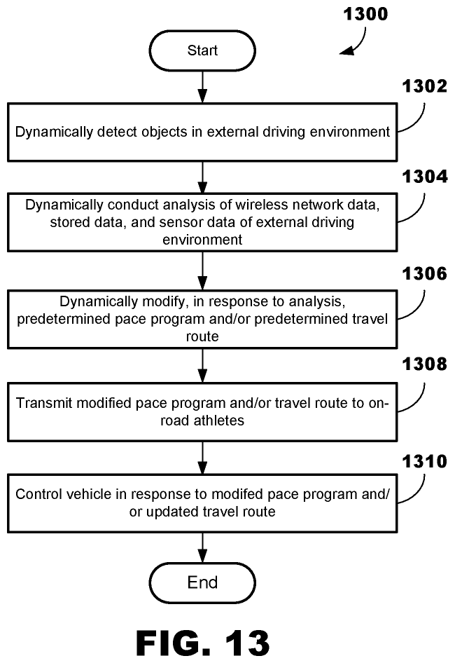

As illustrated in FIG. 13, illustrated process block 1302 includes dynamically detecting, as sensor data, objects in a driving environment located externally to the vehicle. In accordance with one or more embodiments, execution of process block 1302 may be performed by one or more of the control module/ECU 101, the autonomous driving module 102, the object detection module 104, the object tracking module 105, the sensor system 109, and the navigation system 110g. At least a portion of an external driving environment of the vehicle 100 may be dynamically sensed to detect objects. For example, the vehicle 100 may sense or detect the external driving environment in one or more directions, such as: a lateral direction relative to the longitudinal axis of the vehicle 100, an aft direction relative to the longitudinal axis of the vehicle 100, and a fore direction relative to the longitudinal axis of the vehicle 100.

The method 1300 may then proceed to illustrated process block 1304, which includes dynamically conducting an analysis of wireless network data, stored data, and the sensor data. In accordance with one or more embodiments, execution of process block 1304 may be performed by one or more of the control module/ECU 101 and the autonomous driving module 102.

The method 1300 may then proceed to illustrated process block 1306, which includes dynamically updating, in response to the analysis, wireless network data, and stored data, one or more of the predetermined pace program and the predetermined travel route. In accordance with one or more embodiments, execution of process block 1306 may be performed by one or more of the control module/ECU 101 and the autonomous driving module 102.

The method 1300 may then proceed to illustrated process block 1308, which includes automatically transmitting the updated pace program and/or the updated travel route to the peloton 200. In accordance with one or more embodiments, execution of process block 1308 may be performed by one or more of the control module/ECU 101 and the autonomous driving module 102.

The method 1300 may then proceed to illustrated process block 1310, which includes controlling the vehicle, in response to the updated pace program and/or the updated travel route. In accordance with one or more embodiments, execution of process block 1006 may be performed by the control module/ECU 101 and the autonomous driving module 102.

The method 1300 may terminate or end when the vehicle 100 is caused to execute or implement the driving maneuver in view of the updated pace program and/or the updated travel route. Alternatively, the method 1300 may return to start or process block 1302. In accordance with one or more embodiments, one or more of the control module/ECU 101 and the autonomous driving module 102 may cause the vehicle 100 to implement the driving maneuver. In this regard, one or more of the control module/ECU 101 and the autonomous driving module 102 may be operatively connected to one or more of the vehicle systems 110 to cause the driving maneuver to be implemented. Alternatively or additionally, one or more of the control module/ECU 101 and the autonomous driving module 102 may be operatively connected to and control the one or more actuators 111, which may control one or more of the vehicle systems 110 or portions thereof to implement the driving maneuver. 5555

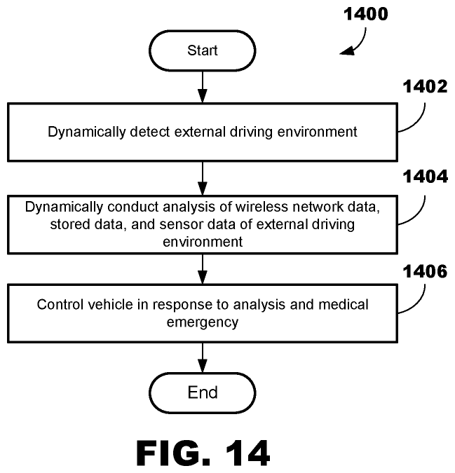

As illustrated in FIG. 14, illustrated process block 1402 includes dynamically detecting, as sensor data, a driving environment located externally to the vehicle, including health data of the one or more on-road persons, traffic data, and road data. In accordance with one or more embodiments, execution of process block 1002 may be performed by one or more of the control module/ECU 101, the object detection module 104, the object tracking module 105, the sensor system 109, and the navigation system 110g. At least a portion of an external driving environment of the vehicle 100 may be dynamically sensed to detect objects. For example, the vehicle 100 may sense or detect the external driving environment in one or more directions, such as: a lateral direction relative to the longitudinal axis of the vehicle 100, an aft direction relative to the longitudinal axis of the vehicle 100, and a fore direction relative to the longitudinal axis of the vehicle 100.

The method 1400 may then proceed to illustrated process block 1404, which includes dynamically conducting an analysis of wireless network data, stored data, and the sensor data. In accordance with one or more embodiments, execution of process block 1404 may be performed by one or more of the control module/ECU 101 and the autonomous driving module 102.

The method 1400 may then proceed to illustrated process block 1406, which includes controlling the vehicle, in response to the analysis that reveals a medical emergency based on a current health condition of an on-road person in the peloton, by causing the vehicle to implement a driving maneuver which positions the vehicle in a protective position relative to the on-road person. In accordance with one or more embodiments, execution of process block 1406 may be performed by one or more of the control module/ECU 101 and the autonomous driving module 102. Alternatively or additionally, one or more of the control module/ECU 101 and the autonomous driving module 102 may be operatively connected to and control the one or more actuators 111, which may control one or more of the vehicle systems 110 or portions thereof to implement the driving maneuver.

The method 1406 may terminate or end when the vehicle 100 is caused to execute or implement the driving maneuver.

The terms “coupled,” “attached,” or “connected” may be used herein to refer to any type of relationship, direct or indirect, between the components in question, and may apply to electrical, mechanical, fluid, optical, electromagnetic, electromechanical or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A system for operating a vehicle, when operating at least partially in an autonomous mode, as a support vehicle for one or more on-road persons in a peloton configuration engaged in a cycling, running, and/or walking activity on a predetermined travel route at a predetermined pace, the system comprising:
one or more processors; and
a non-transitory memory operatively coupled to the one or more processors comprising a set of instructions executable by the one or more processors to cause the one or more processors to:
dynamically conduct an analysis of wireless network data, stored data, and sensor data relating to information about an external driving environment in which the vehicle is operating, including health data of the one or more on-road persons, traffic data, and road data;
dynamically determine, based on the analysis, one or more of a current health status of the one or more on-road persons, a current traffic condition along the predetermined travel route, and a current road condition along the predetermined travel route; and
control the vehicle, in response to the determination, by causing the vehicle to transmit one or more of a visual warning signal, an audio warning signal, and a haptic warning signal to the one or more on-road persons.

2. The system of claim 1, wherein the set of instructions cause the one or more processors to control the vehicle, in response to the determination of the current traffic condition along the predetermined travel route, by causing the vehicle to implement a driving maneuver that maintains a predetermined distance in front of the one or more persons.

3. The system of claim 1, wherein the set of instructions cause the one or more processors to control the vehicle, in response to the determination of the current traffic condition along the predetermined travel route, by causing the vehicle to implement a driving maneuver to change its lane and road position relative to the peloton.

4. The system of claim 1, wherein the set of instructions cause the one or more processors to control the vehicle, in response to the determination of the current traffic condition along the predetermined travel route, by causing the vehicle to implement a driving maneuver that automatically modifies the predetermined travel route.

5. The system of claim 1, wherein the set of instructions cause the one or more processors to control the vehicle, in response to the determination of the current traffic condition along the predetermined travel route, by causing the vehicle to implement a driving maneuver that automatically modifies the predetermined pace.

6. The system of claim 1, wherein the set of instructions cause the one or more processors to control the vehicle, in response to the determination of the current road condition along the predetermined travel route, by causing the vehicle to implement a driving maneuver that maintains a predetermined distance in front of the one or more persons.

7. The system of claim 1, wherein the set of instructions cause the one or more processors to control the vehicle, in response to the determination of the current road condition along the predetermined travel route, by causing the vehicle to implement a driving maneuver to change its lane and road position relative to the peloton.

8. The system of claim 1, wherein the set of instructions cause the one or more processors to control the vehicle, in response to a determination of the current road condition along the predetermined travel route, by causing the vehicle to implement a driving maneuver that one automatically modifies the predetermined route.

9. The system of claim 1, wherein the set of instructions cause the one or more processors to control the vehicle, in response to the determination of the current road condition along the predetermined travel route, by causing the vehicle to implement a driving maneuver that automatically modifies the predetermined pace.

10. The system of claim 1, wherein the set of instructions cause the one or more processors to control the vehicle, in response to a determination of a medical emergency, by causing the vehicle to transmit a request for medical assistance.

11. A method of operating a vehicle, when operating at least partially in an autonomous mode, as a support vehicle for one or more on-road persons in a peloton configuration that are engaged in a cycling, running, and/or walking activity on a predetermined travel route at a predetermined pace, the method comprising:
dynamically conducting an analysis of wireless network data, stored data, and sensor data relating to information about an external driving environment in which the vehicle is operating, including health data of the one or more on-road persons, traffic data, and road data;
dynamically determining, based on the analysis, one or more of a current health status of the one or more on-road persons, a current traffic condition along the predetermined travel route, and a current road condition along the predetermined travel route; and
controlling the vehicle, in response to the determination, by causing the vehicle to transmit one or more of a visual warning signal, an audio warning signal, and a haptic warning signal to the one or more on-road persons.

12. The method of claim 11, further comprising controlling the vehicle, in response to the determination of the current traffic condition along the predetermined travel route, by causing the vehicle to implement a driving maneuver that maintains a predetermined distance in front of the one or more persons.

13. The method of claim 11, further comprising controlling the vehicle, in response to the determination of the current traffic condition along the predetermined travel route, by causing the vehicle to implement a driving maneuver to change its lane and road position relative to the peloton.

14. The method of claim 11, further comprising controlling the vehicle, in response to the determination of the current traffic condition along the predetermined travel route, by causing the vehicle to implement a driving maneuver that automatically modifies the predetermined travel route.

15. The method of claim 11, further comprising controlling the vehicle, in response to the determination of the current traffic condition along the predetermined travel route, by causing the vehicle to implement a driving maneuver that automatically modifies the predetermined pace.

16. The method of claim 11, further comprising controlling the vehicle, in response to the determination of the current road condition along the predetermined travel route, by causing the vehicle to implement a driving maneuver that maintains a predetermined distance in front of the one or more persons.

17. The method of claim 11, further comprising controlling the vehicle, in response to the determination of the current road condition along the predetermined travel route, by causing the vehicle to implement a driving maneuver that one automatically modifies the predetermined route.

18. The method of claim 11, further comprising controlling the vehicle, in response to the determination of the current road condition along the predetermined travel route, by causing the vehicle to implement a driving maneuver that automatically modifies the predetermined pace.

19. The method of claim 11, further comprising controlling the vehicle, in response to the determination of a determination of a medical emergency, by causing the vehicle to transmit a request for medical assistance.

20. A computer program product for operating a vehicle, when operating at least partially in an autonomous mode, as a support vehicle for one or more on-road persons in a peloton configuration that are engaged in a cycling, running, and/or walking activity on a predetermined travel route at a predetermined pace, the computer program product including at least one computer readable medium, comprising a set of instructions, which when executed by one or more processors, cause the one or more processors to:
dynamically conduct an analysis of wireless network data, stored data, and sensor data relating to information about an external driving environment in which the vehicle is operating, including health data of the one or more on-road persons, traffic data, and road data;
dynamically determine, based on the analysis, one or more of a current health status of the one or more on-road persons, a current traffic condition along the predetermined travel route, and a current road condition along the predetermined travel route; and
control the vehicle, in response to the determination, by causing the vehicle to transmit one or more of a visual warning signal, an audio warning signal, and a haptic warning signal to the one or more on-road persons.

21. The computer program product of claim 20, wherein the set of instructions cause the one or more processors to control the vehicle, in response to the determination of the current traffic condition along the predetermined travel route, by causing the vehicle to implement a driving maneuver that maintains a predetermined distance in front of the one or more persons.

22. The computer program product of claim 20, wherein the set of instructions cause the one or more processors to control the vehicle, in response to the determination of the current traffic condition along the predetermined travel route, by causing the vehicle to implement a driving maneuver to change its lane and road position relative to the peloton.

23. The computer program product of claim 20, wherein the set of instructions cause the one or more processors to control the vehicle, in response to the determination of the current traffic condition along the predetermined travel route, by causing the vehicle to implement a driving maneuver that automatically modifies the predetermined travel route.

24. The computer program product of claim 20, wherein the set of instructions cause the one or more processors to control the vehicle, in response to the determination of the current traffic condition along the predetermined travel route, by causing the vehicle to implement a driving maneuver that automatically modifies the predetermined pace.

25. The computer program product of claim 20, wherein the set of instructions cause the one or more processors to control the vehicle, in response to the determination of the current road condition along the predetermined travel route, by causing the vehicle to implement a driving maneuver that maintains a predetermined distance in front of the one or more persons.

26. The computer program product of claim 20, wherein the set of instructions cause the one or more processors to control the vehicle, in response to a determination of the current road condition along the predetermined travel route, by causing the vehicle to implement a driving maneuver that one automatically modifies the predetermined route.

27. The computer program product of claim 20, wherein the set of instructions cause the one or more processors to control the vehicle, in response to a determination of the current road condition along the predetermined travel route, by causing the vehicle to implement a driving maneuver that automatically modifies the predetermined pace

28. The computer program product of claim 20, wherein the set of instructions cause the one or more processors to control the vehicle, in response to a determination of a medical emergency, by causing the vehicle to transmit a request for medical assistance.
